(19) United States
(12) Patent Application Publication
(10) Pub. No.: US 2025/0145025 A1
(43) Pub. Date: May 8, 2025

(54) Extended Range Electric Vehicle System

(71) Applicant: Marco Johnson, Highland Park, MI (US)

(72) Inventor: Marco Johnson, Highland Park, MI (US)

(21) Appl. No.: 18/627,565

(22) Filed: Apr. 5, 2024

Related U.S. Application Data
(60) Provisional application No. 63/596,974, filed on Nov. 8, 2023.

(51) Int. Cl. B60L 50/62; B60L 53/16; B60L 58/16

(52) U.S. Cl. CPC B60L 50/62; B60L 53/16; B60L 58/16; B60L 2240/547

(57) ABSTRACT

An electric vehicle system that includes a plurality of Li-ion batteries to alternately provide electric power to propel the vehicle, with a generator motor converting rotational energy from the motors installed in wheels of the vehicle into electric energy for recharging the Li-ion batteries. An onboard computer management system controls the system's operations, including switching between the Li-ion batteries for providing power to the vehicle based on power levels of the Li-ion batteries. The system automatically discontinues charging of a lithium-ion battery when its cut-off point is reached to prevent damage or fire hazards. The system eliminates the need to charge batteries at a charging station, enabling one battery to power the vehicle while the second is charged.

### CROSS-REFERENCE TO RELATED APPLICATION

The present application claims priority to, and the benefit of, U.S. Provisional Application No. 63/596,974, which was filed on Nov. 8, 2023, and is incorporated herein by reference in its entirety.

### FIELD OF THE INVENTION

The present invention generally relates to the field of electric vehicles. More specifically, the present invention relates to a novel electric vehicle system for providing extending travel range while limiting the number of times the batteries need to be charged. The vehicle system has two Li-ion batteries for providing electric power to the vehicle. The batteries alternately provide power with one battery providing power and the other battery getting recharged. Accordingly, the present disclosure makes specific reference thereto. Nonetheless, it is to be appreciated that aspects of the present invention are also equally applicable to other like applications, devices, and methods of manufacture.

### BACKGROUND

By way of background, traditional gas-powered vehicles have been used for centuries and have a lot of disadvantages. Traditional gas-powered vehicles contribute to air pollution and climate change by emitting harmful gases such as carbon dioxide, nitrogen oxides, and particulate matter. Further, gas-powered vehicles rely on non-renewable fossil fuels, which are a finite resource. Electric vehicles have been developed as an alternative to traditional vehicles and have the potential to significantly reduce fossil fuel consumption and air pollution. Electric vehicles do not produce harmful emissions that contribute to climate change and air pollution. However, while electric vehicles are environmentally conscious, they present some challenges for users in terms of charging and driving (i.e., travel) range.

Currently, electric vehicles batteries have limited power and provide limited driving range. Electric vehicle batteries can only provide power for a certain distance before needing to be recharged. Therefore, electric vehicle owners plan their trips carefully without risk of running out of power on the road. In addition, charging times for electric vehicles are often longer than filling up a gas tank, which means that recharging the battery can take a significant amount of time. Frequent stoppages for recharging batteries are also a big problem for electric vehicle owners.

Another challenge with electric vehicles is the lack of charging infrastructure. There are currently fewer charging stations available compared to gas stations, which can make it difficult for drivers to find a place to charge their vehicle while on the road. Furthermore, the charging infrastructures are not yet universally standardized. Different charging systems and connectors may be required for different types of electric vehicles, which can make it difficult for drivers to find a compatible charging station. People desire improved electric vehicles and electric vehicles charging systems that overcome problems of conventional electric vehicles.

Therefore, there exists a long felt need in the art for an electric vehicle designed for extending travel range while limiting the number of times the batteries need to be charged. There is also a long felt need in the art for an electric vehicle charging system that maintains consistent power to the electric vehicle. Additionally, there is a long felt need in the art for an electric vehicle system that eliminates frequent recharging of batteries at charging stations. Moreover, there is a long felt need in the art for an electric vehicle that enables people to travel long distances without worrying of running out of power. Further, there is a long felt need in the art of an electric vehicle charging system that eliminates the need to charge batteries at a charging station. Finally, there is a long felt need in the art for an electric vehicle that provides two lithium-ion batteries which provides the power alternately while getting charged for extended travel range.

The subject matter disclosed and claimed herein, in one embodiment thereof, comprises an extended range electric vehicle system. The system further comprising a pair of Li-ion batteries configured to alternately provide electric power to the vehicle, a left alternator and a left motor installed in the left front wheel, a right alternator and a right motor installed in the right front wheel, a generator motor installed at the rear section of the vehicle, the generator motor is configured to convert rotational energy from the left and right motors into electric energy for recharging the Li-ion batteries, an onboard computer management system configured to control the system's operations, including switching between the Li-ion batteries for providing electric power to the vehicle depending on their respective remaining power levels. The alternators provide direct current to the vehicle's electric circuit and components.

In this manner, the extended range electric vehicle system of the present invention accomplishes all of the forgoing objectives and provides users with an electric vehicle designed for extending travel range while limiting the number of times the batteries need to be charged. The system features motors and alternators within each front wheel to generate power and transfer it to a generator motor for supplying power to the batteries for providing power to the vehicle. The system automatically switches batteries for recharging and providing power based on their respective remaining power levels.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises an extended range electric vehicle system. The system further comprising a pair of identical Li-ion batteries configured to alternately provide electric power to the vehicle, a left alternator and a left motor installed in the left front wheel, a right alternator and a right motor installed in the right front wheel, a generator motor installed at the rear section of the vehicle, the generator motor is configured to convert rotational energy from the left and right motors into electric energy for recharging the Li-ion batteries, an onboard computer management system configured to control the system's operations, including switching between the Li-ion batteries for providing electric power to the vehicle depending on their respective remaining power levels.

In yet another embodiment, a mobile self-charging electric vehicle system is disclosed. The system comprising a pair of Li-ion batteries, each Li-ion battery having a cycle life of 500 to 2,500 cycles and a capacity ranging from 20 kWh to 100 kWh, a left alternator and a left motor installed in the left front wheel, a right alternator and a right motor installed in the right front wheel. The Li-ion batteries are used to alternately provide electric power to propel the vehicle, and the generator motor converts rotational energy from the left and right motors into electric energy for recharging the Li-ion batteries. The left and right alternators are configured to rotate upon rotation of the front wheels to provide low-level electric power to the vehicle accessories such as dashboard and locking system. An onboard computer management system prevents overheating of the Li-ion batteries and switches between the Li-ion batteries depending on their respective remaining power levels.

In a further embodiment, a method for providing power to an electric vehicle is described. The method includes the steps of initially using a first Li-ion battery to provide power to the vehicle, checking the power level of the first Li-ion battery to determine if the power level of the first Li-ion battery is greater than a predetermined threshold, if the power level of the first Li-ion battery is greater than the predetermined threshold, continuing to use the first Li-ion battery power, if the first Li-ion battery is less than the predetermined threshold switching to the second Li-ion battery and using its power, and recharging the depleted first Li-ion battery using a generator motor wherein the generator motor generator electric power using rotational energy produced by motors positioned in front wheels of the electric vehicle.

In yet another embodiment, the system automatically discontinues charging of a lithium-ion battery if its cut-off point is reached, wherein the cut-off is set at 99% of the battery's total power capacity, to prevent damage or fire hazards.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a functional block diagram of one potential embodiment of a mobile self-charging electric vehicle system of the present invention in accordance with the disclosed architecture;

FIG. 2 illustrates a top perspective view of the extended range electric vehicle frame having the mobile self-charging electric vehicle system of the present invention in accordance with the disclosed architecture;

FIG. 3 illustrates a side perspective view of the vehicle frame showing installation of an alternator and motor in a wheel in accordance with the disclosed architecture;

FIG. 4 illustrates a flow diagram depicting the process by which the EREV system manages the use of two lithium-ion batteries for providing electronic power for running the vehicle in accordance with the disclosed architecture;

FIG. 5 illustrates a flow diagram depicting a process of switching between Li-ion batteries of the system of the present invention in accordance with the disclosed architecture;

FIG. 6 illustrates a flow diagram depicting a process of recharging Li-ion batteries of the EREV system using rotation of front wheels of the vehicle in accordance with the disclosed architecture; and

FIG. 7 illustrates a flow diagram depicting a process of the temperature management of the Li-ion batteries of the electric vehicle system for preventing overheating and over charging in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long felt need in the art for an electric vehicle designed for extending travel range while limiting the number of times the batteries need to be charged. There is also a long felt need in the art for an electric vehicle charging system that maintains consistent power to the electric vehicle. Additionally, there is a long felt need in the art for an electric vehicle system that eliminates frequent recharging of batteries at charging stations. Moreover, there is a long felt need in the art for an electric vehicle that enables people to travel long distances without worrying of running out of power. Further, there is a long felt need in the art of an electric vehicle charging system that eliminates the need to charge batteries at a charging station. Finally, there is a long felt need in the art for an electric vehicle that provides two lithium-ion batteries which provides the power alternately while getting charged for extended travel range.

The present invention, in one exemplary embodiment, is a method for generating additional power to an electric vehicle. The method includes the steps of initially using a first Li-ion battery to provide power to the vehicle, checking the power level of the first Li-ion battery to determine if the power level of the first Li-ion battery is greater than a predetermined threshold, if the power level of the first Li-ion battery is greater than predetermined threshold, continuing to use the first Li-ion battery power, if the power level of the first Li-ion battery is below the threshold switching to the second Li-ion battery and using its power, and recharging the depleted first Li-ion battery using a generator motor wherein the generator motor generator electric power using rotational energy produced by motors positioned in the front wheels of the electric vehicle.

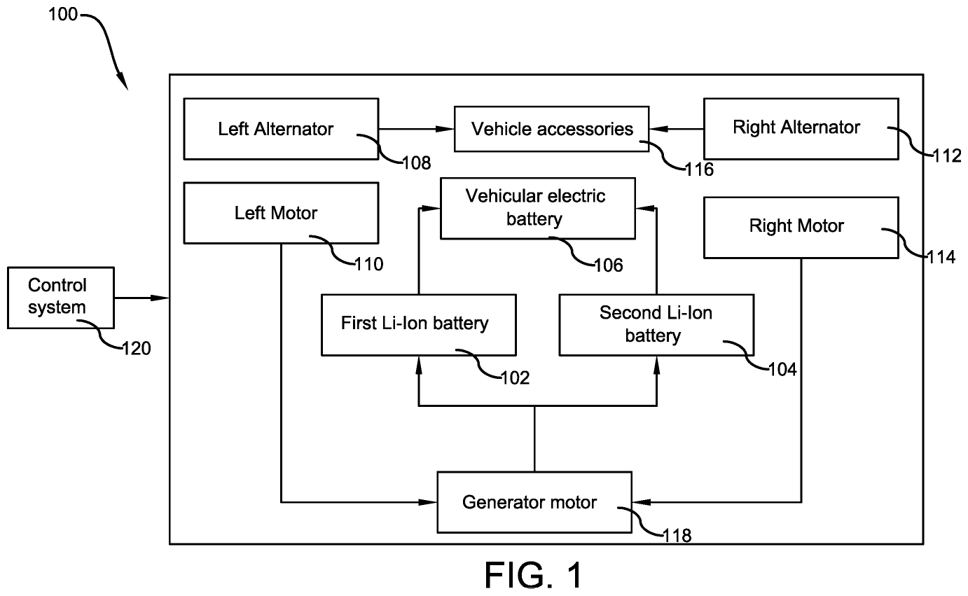

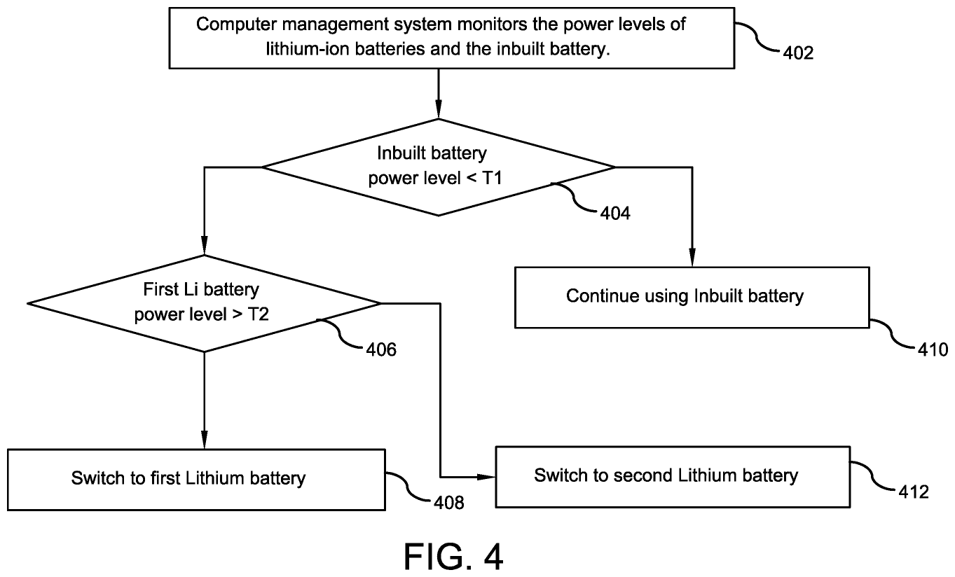

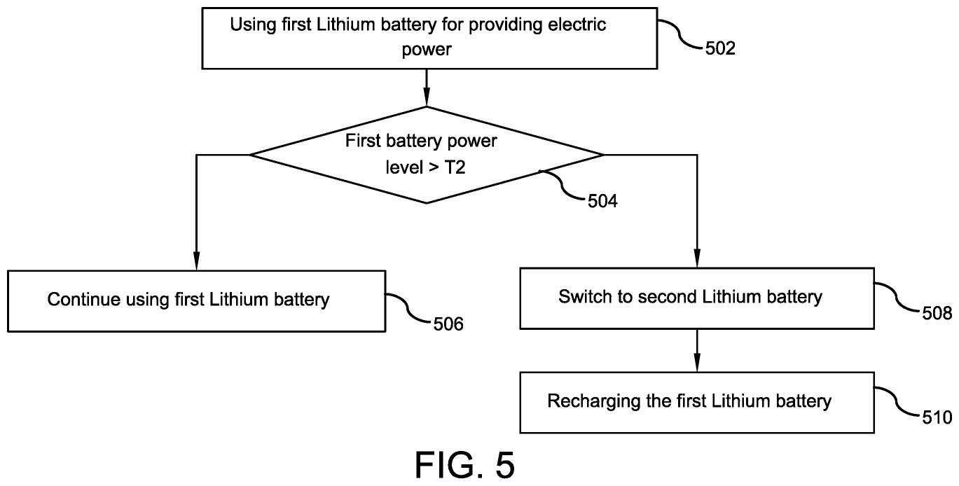

Referring initially to the drawings, FIG. 1 illustrates a functional block diagram of one potential embodiment of a mobile self-charging electric vehicle system of the present invention in accordance with the disclosed architecture. The mobile self-charging electric vehicle system 100 of the present invention is designed as an electric vehicle for extending travel range while limiting the number of times the batteries need to be charged. The system 100 can be designed as an electric vehicle, integrated into an electric vehicle during manufacturing of the vehicle or alternatively, can be retrofitted into an existing vehicle. The mobile self-charging electric vehicle system 100 enables vehicle owners to consistently maintain power to their electric vehicle. More specifically, the system 100 includes a pair of Li-ion batteries including a first Li-ion battery 102 and a second Li-ion battery 104. The Li-ion batteries 102, 104 are identical and are configured to alternately provide electric power to vehicular electric battery 106 as described in FIGS. 4 and 5.

Depending on design and configuration of the electric vehicle system 100, the capacity of each lithium-ion battery can range from around 20 kilowatt-hours (kWh) for smaller models, to about 100 kWh for larger models. The cycle life of each lithium-ion battery can be in the range of 500 to 2,500 cycles, wherein the cycle life of the lithium-ion batteries 102, 104 refers to the number of charge and discharge cycles that each battery can undergo before its capacity is significantly reduced. The system 100 uses lithium-ion batteries 102, 104 as they offer several advantages over traditional lead-acid batteries, including a higher energy density, faster charging times, and longer cycle life.

The system 100 includes a left alternator 108 and left motor 110 in a left front wheel of the vehicle and a right alternator 112 and right motor 114 in a right front wheel of the vehicle. The left alternator and motor 108, 110 and the right alternator and motor 110, 114 are configured to rotate in a synchronized manner upon movement of the vehicle. Installation of the alternators 108, 112 and motors 110, 114 in the wheels of the vehicle saves space inside the vehicle. The left alternator 108 and the right alternator 112 are configured to rotate upon rotation of the front wheels to produce direct current (DC) for providing low-level electric power to the vehicle accessories 116 such as dashboard, central locking system, and more. The left alternator 108 and the right alternator 112 do not require any external force other than movement of the left wheel and right wheel respectively for rotation.

The left motor 110 and the right motor 114 are configured to rotate upon movement of the left wheel and right wheel respectively and provide rotational energy to the generator motor 118. The generator motor 118 is preferably installed at the rear section of the vehicle frame and upon receiving rotational energy, converts the rotational energy into electric energy for recharging the Li-ion batteries 102, 104. The generator motor 118 in the present invention operates using the principles of electromagnetic induction, where a magnetic field is generated by a rotating rotor, which in turn induces a current in a wire coil. The rotor is rotated using the rotational energy received from the left motor 110 and the right motor 114.

The extended range electric vehicle (EREV) system 100 is controlled by an onboard computer management system 120. The onboard computer management system 120 automatically controls operations of the system 100 for preventing overheating of the batteries 102, 104 and providing power from one of the batteries 102, 104 to the vehicular electric battery 106. In the extended range electric vehicle system 100, only one of the first Li-ion battery 102 and the second Li-ion battery 104 provides electric power to the vehicular electric battery 106 at an instance while the other Li-ion battery is recharged by the generator motor 118. The switching between the Li-ion batteries 102, 104 is performed by the onboard computer management system 120 depending on remaining power levels of the Li-ion batteries 102, 104 as described in FIG. 5. It should be noted that the specific specifications of the computer management system 120 can vary depending on the specific make and model of the vehicle.

It should be noted that the built-in battery 106 is optional and in some embodiments of the present invention, the Li-ion batteries 102, 104 directly provide power to the vehicle and built-in battery 106 of the vehicle is not required. In such cases, Li-ion batteries 102, 104 propel the vehicle forward by providing power to the motors 110, 112.

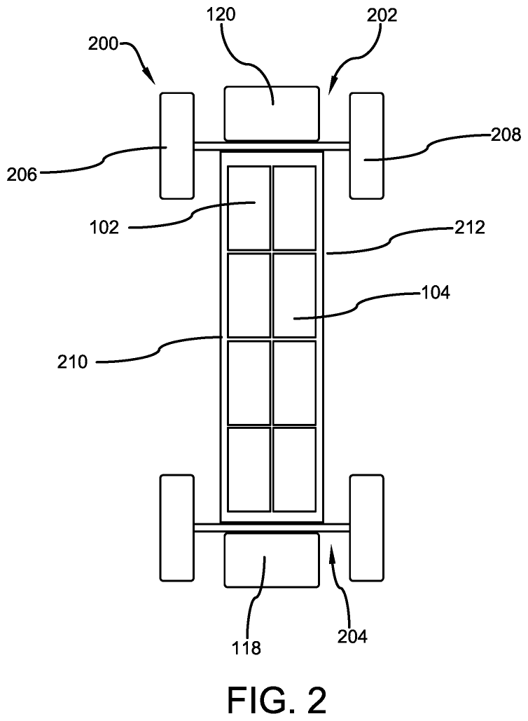

FIG. 2 illustrates a top perspective view of the extended range electric vehicle frame having the mobile self-charging electric vehicle system of the present invention in accordance with the disclosed architecture. The onboard computer management system 120 is positioned in front 202 of the vehicle frame 200 and the generator motor 118 is installed at the rear section 204 of the vehicle frame 200. The generator motor 118 is installed at the rear section 204 to balance weight of the frame 200 and for an effective coupling of the generator motor 118 with the Li-ion batteries 102, 104.

The first Li-ion battery 102 and the second Li-ion battery 104 are identical and extend between the front section 202 and rear section 204 of the vehicle frame 200. It should be noted that the first Li-ion battery 102 and the second Li-ion battery 104 function as independent batteries (i.e., not connected in series nor in parallel) and are designed to power the vehicle independently. The Li-ion batteries 102, 104 form the base of the vehicle frame 200 and can be protected by metal casing (not shown) for protection from physical damage.

The left front wheel 206 includes the left alternator 108 and left motor 110 as described in FIG. 1 and the right front wheel 208 includes the right alternator 112 and right motor 114. The left motor 110 is connected to the generator motor 118 via the internal circuit 210 and similarly, the right motor 114 is connected to the generator motor 118 via the internal circuit 212.

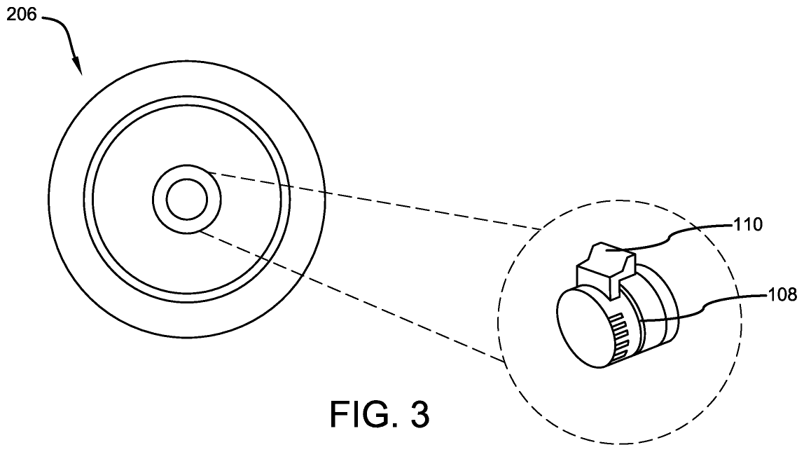

FIG. 3 illustrates a side perspective view of the vehicle frame showing installation of an alternator and motor in a wheel in accordance with the disclosed architecture. As illustrated, the left alternator 108 and the left motor 110 are installed within the left front wheel 206. Upon rotation of the left front wheel 206, the left alternator 108 and the left motor 110 rotate for producing direct current and rotational energy respectively. The left alternator 108 and the left motor 110 can be removed for diagnostic purposes and also do not impact the movement of the wheel 206. Similarly, the right alternator 112 and right motor 114 are installed within the right front wheel 208.

FIG. 4 illustrates a flow diagram depicting the process by which the EREV system manages the use of two lithium-ion batteries for providing electronic power for running the vehicle in accordance with the disclosed architecture. Initially, as the EREV is driven, the computer management system 120 constantly monitors the power levels of both lithium-ion batteries 102, 104, as well as the power level of the built-in battery of the vehicle (Step 402).

Then, the power level of the built-in battery is detected (Step 404) and if the power level of the built-in battery drops below a certain threshold level, which is denoted by T1 and can be 90% of total power value of the built-in battery, then the EREV system checks the power level of the first lithium-ion battery (Step 406). If the power level of the first lithium-ion battery 102 is greater than another threshold level, denoted by T2 which can be 50% of total power of the first Li-ion battery 102, then the EREV system switches over to using the first lithium-ion battery 102 to power the vehicle (Step 408). If the power level of the built-in battery 106 is above T1, then, the built-in battery 106 is continued to be used (Step 410).

The switching from the built-in battery 106 to the first lithium-ion battery 102 as described enables the vehicle to move without requiring additional charging. In other embodiments of the present invention, initial switching can also be done with the second Li-ion battery 104 depending upon the configuration of the system 100. If the power level of the initial lithium-ion battery is less than T2, then the EREV system switches to the first lithium-ion battery 102 (Step 412).

FIG. 5 illustrates a flow diagram depicting a process of switching between Li-ion batteries of the system 100 of the present invention in accordance with the disclosed architecture. Initially, the system 100 uses the first Li-ion battery 102 for providing power to the vehicle as described in FIG. 4 (Step 502). Then, the system 100 checks the power level of the first lithium-ion battery 102 (Step 504). If the power level of the first lithium-ion battery 102 is greater than T2, then the system continues to use the first lithium-ion battery power (Step 506). Otherwise, the system 100 switches to the second lithium-ion battery and begins using its power (Step 508). At the same time, the depleted first lithium-ion battery is recharged using the generator motor 118, so that it can be ready for use again when needed (Step 510). It should be noted that regardless of which Li-ion battery is being used, the system 100 constantly monitors the power levels of both batteries 102, 104.

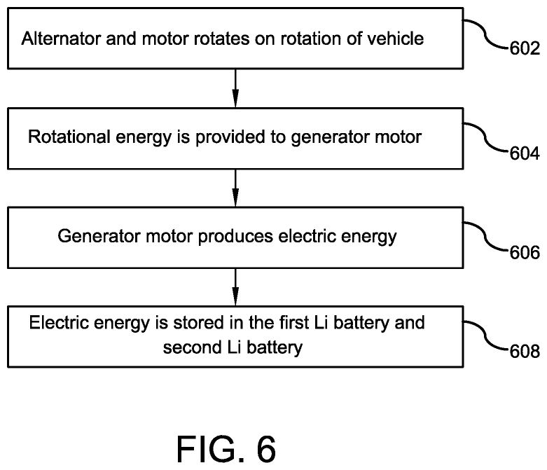

FIG. 6 illustrates a flow diagram depicting a process of recharging Li-ion batteries of the EREV system using rotation of front wheels of the vehicle in accordance with the disclosed architecture. Initially, the process begins with the rotation of the vehicle's wheels, which activates the alternator/motors in each front wheel (Step 602). Then, the rotational energy from the wheels is then provided to the generator motor as described in FIG. 2 (Step 604). The rotational energy is used to produce electrical energy by the generator motor (Step 606) and once the electrical energy is generated, it is then stored in both the first lithium-ion battery and the second lithium-ion battery, which are part of the EREV system (Step 608). By relying on the rotational energy of the wheels, the system 100 is able to generate and store electrical energy without relying on external sources, making it a highly efficient and self-sustaining system.

It should be noted that in cases where one of the lithium-ion batteries is providing electric power to the vehicle, then, the electric generator motor 118 does not recharge the battery simultaneously and recharges only the other Li-ion battery. The control system 120 constantly monitors the Li-ion batteries for recharging from the electric generator motor 118.

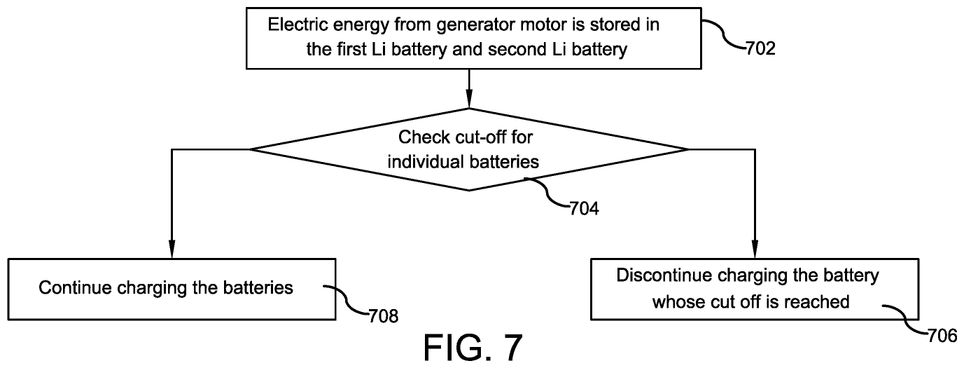

FIG. 7 illustrates a flow diagram depicting a process of the temperature management of the Li-ion batteries of the electric vehicle system 100 for preventing over heating and over charging in accordance with the disclosed architecture. Initially, the electrical energy generated by the generator motor 118 is stored in both the first lithium-ion battery 102 and the second lithium-ion battery 104 (Step 702). The system 100 checks the cut-off for each individual battery (Step 704). The cut-off can be 99% of the total power capacity of each battery. If the cut-off for either the first or second battery is reached, then charging for that battery is discontinued (Step 706). This is done automatically by the control system 120 because overcharging a lithium-ion battery can cause damage to the battery or even cause it to catch fire. If the cut-off for both batteries 102, 104 has not been reached, then charging continues until they are fully charged (Step 708). This helps to ensure that the batteries 102, 104 are always at their maximum capacity and ready to provide power to the vehicle.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “electric vehicle system”, “EREV system”, “mobile self-charging electric vehicle system”, “extended range electric vehicle system”, and “system” are interchangeable and refer to the extended range electric vehicle system 100 of the present invention.

Notwithstanding the forgoing, the extended range electric vehicle system 100 of the present invention can be of any suitable size and configuration as is known in the art without affecting the overall concept of the invention, provided that it accomplishes the above stated objectives. One of ordinary skill in the art will appreciate that the extended range electric vehicle system 100 as shown in the FIGS. are for illustrative purposes only, and that many other sizes and shapes of the extended range electric vehicle system 100 are well within the scope of the present disclosure. Although the dimensions of the extended range electric vehicle system 100 are important design parameters for user convenience, the extended range electric vehicle system 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A mobile self-charging electric vehicle system comprising:
an extended range electric vehicle (EREV) having a plurality of Li-ion batteries and a generator motor;
wherein said plurality of Li-ion batteries including at least a first Li-ion battery and a second Li-ion battery;
wherein said first Li-ion battery and said second Li-ion battery alternately provide electric power to a vehicular electric battery;
wherein said first Li-ion battery and said second Li-ion battery having a capacity in the range from 20 kilowatt-hours (kWh) to 100 kWh;
a left alternator and a left motor mounted in a left wheel of said EREV;
a right alternator and a right motor mounted in a right wheel of said EREV;
wherein said left alternator, said left motor, said right alternator, and said right motor rotate in a synchronized manner upon rotation of wheels of said EREV;
wherein said left alternator and said right alternator rotate upon rotation of the wheels to produce direct current (DC) for providing low-level electric power to said EREV accessories;
wherein said left motor and said right motor rotate upon respective movement of the left wheel and the right wheel and provide rotational energy to a generator motor;
wherein said generator motor receiving rotational energy from rotating said left motor and said right motor; and
further wherein said generator motor converts said rotational energy into electric energy for selectively recharging said first Li-ion battery or said second Li-ion battery.

2. The mobile self-charging electric vehicle system of claim 1, wherein said generator motor having a rotating rotor for generating a magnetic field and inducing a current in a wire coil.

3. The mobile self-charging electric vehicle system of claim 2, wherein said rotor is rotated using said rotational energy received from said left motor and said right motor.

4. The mobile self-charging electric vehicle system of claim 2 further comprising an onboard computer management system for controlling operations of said first Li-ion battery and said second Li-ion battery, and further wherein said onboard computer management system routes power from one of said first Li-ion battery or said second Li-ion battery to a vehicular electric battery.

5. The mobile self-charging electric vehicle system of claim 4, wherein said generator motor recharges another of said first Li-ion battery or said second Li-ion battery while said one of said first Li-ion battery or said second Li-ion battery provides power to a vehicular electric battery.

6. The mobile self-charging electric vehicle system of claim 5, wherein said generator motor mounted at a rear section of said EREV.

7. The mobile self-charging electric vehicle system of claim 5, wherein said onboard computer management system switches between said first Li-ion battery and said second Li-ion battery depending on a remaining power level of said first Li-ion battery and said second Li-ion battery.

8. The mobile self-charging electric vehicle system of claim 7, wherein said first Li-ion and said second Li-ion batteries having cycle lives in the range from 500 cycles to 2,500 cycles.

9. The mobile self-charging electric vehicle system of claim 8, wherein said accessories include said EREV dashboard components and a central locking system.

10. The mobile self-charging electric vehicle system of claim 7, wherein said first Li-ion and said second Li-ion batteries are independent from one another.

11. A method of self-charging an electric vehicle, the method comprising the steps of:
providing an extended range electric vehicle (EREV) having a first Li-ion battery, a first motor, a first alternator, a second Li-ion battery, a second motor, a second alternator, and a generator motor;
rotating said first alternator, said first motor, said second alternator, and said second motor in a synchronized manner upon rotation of wheels of said EREV;
wherein said first alternator and said second alternator rotate upon rotation of the wheels to produce direct current (DC) for providing low-level electric power;
wherein said first motor and said second motor rotate upon respective movement of the first wheel and the second wheel;
wherein said generator motor receiving rotational energy from rotating said first motor and said second motor;
wherein said generator motor converts said rotational energy into electric energy;
selectively recharging said first Li-ion battery or said second Li-ion battery with said electrical energy;
monitoring power levels of said first Li-ion battery, said second Li-ion battery, and the vehicular electric battery; and
alternating discharge of energy from said first Li-ion battery and said second Li-ion battery based on a detected power level of said first Li-ion battery and said second Li-ion battery to provide electric power to a vehicular electric battery, wherein said alternating discharge of energy based on a detected power level of the vehicular electric battery.

12. The method of self-charging an electric vehicle of claim 11, wherein said generator motor having a rotating rotor for generating a magnetic field and inducing a current in a wire coil.

13. The method of self-charging an electric vehicle of claim 11, wherein said rotor is rotated using said rotational energy received from said first motor and said second motor.

14. The method of self-charging an electric vehicle of claim 11 further comprising an onboard computer management system for controlling operations of said first Li-ion battery and said second Li-ion battery, and further wherein said onboard computer management system routes power from one of said first Li-ion battery or said second Li-ion battery to the vehicular electric battery.

15. The method of self-charging an electric vehicle of claim 11, wherein said generator motor recharges another of said first Li-ion battery or said second Li-ion battery while said one of said first Li-ion battery or said second Li-ion battery provides power to the vehicular electric battery.

16. The method of self-charging an electric vehicle of claim 14, wherein said onboard computer management system switches between said first Li-ion battery and said second Li-ion battery depending on a remaining power level of said first Li-ion battery and said second Li-ion battery.

17. The method of self-charging an electric vehicle of claim 11, wherein said first Li-ion and said second Li-ion batteries having cycle lives in the range from 500 cycles to 2,500 cycles.

18. The method of self-charging an electric vehicle of claim 11, wherein said first alternator and said second alternator rotate upon rotation of the wheels to produce direct current (DC) for providing low-level electric power to said EREV accessories, and further wherein said accessories include said EREV dashboard components and a central locking system.

19. The method of self-charging an electric vehicle of claim 11, wherein said first Li-ion and said second Li-ion batteries are independent from one another.

20. A method of self-charging an electric vehicle, the method comprising the steps of:
providing an extended range electric vehicle (EREV) having a first Li-ion battery, a first motor, a first alternator, a second Li-ion battery, a second motor, a second alternator, and a generator motor;
wherein said first Li-ion battery and said second Li-ion battery having a capacity in the range from 20 kilowatt-hours (kWh) to 100 kWh;
rotating said first alternator, said first motor, said second alternator, and said second motor in a synchronized manner upon rotation of wheels of said EREV;
wherein said first alternator and said second alternator rotate upon rotation of the wheels to produce direct current (DC) for providing low-level electric power;
wherein said first motor and said second motor rotate upon respective movement of the first wheel and the second wheel and provide rotational energy to said generator motor;
wherein said generator motor receiving rotational energy from rotating said first motor and said second motor;
wherein said generator motor converts said rotational energy into electric energy;
selectively recharging said first Li-ion battery or said second Li-ion battery with said electrical energy;
monitoring power levels of said first Li-ion battery, said second Li-ion battery, and the vehicular electric battery;
alternating discharge of energy from said first Li-ion battery and said second Li-ion battery to provide electric power to a vehicular electric battery; and
further wherein said alternating discharge of energy based on a detected power level of the vehicular electric battery.
